(19) United States
(12) Patent Application Publication
(10) Pub. No.: US 2025/0054703 A1
(43) Pub. Date: Feb. 13, 2025

(54) THROUGH-TYPE MULTILAYER CERAMIC CAPACITOR

(71) Applicant: Murata Manufacturing Co., Ltd., Nagaokakyo-shi (JP)

(72) Inventors: Takashi SAWADA, Nagaokakyo-shi (JP); Kazunori USUI, Nagaokakyo-shi (JP)

(21) Appl. No.: 18/931,158

(22) Filed: Oct. 30, 2024

Related U.S. Application Data
(63) Continuation of application No. PCT/JP2023/013546, filed on Mar. 31, 2023.

(30) Foreign Application Priority Data
Jun. 27, 2022 (JP) 2022-102339

(51) Int. Cl. H01G 4/30; H01G 2/06; H01G 4/008; H01G 4/012; H01G 4/12

(52) U.S. Cl. CPC H01G 4/30; H01G 2/065; H01G 4/008; H01G 4/012; H01G 4/12

(57) ABSTRACT

A through-type multilayer ceramic capacitor includes a multilayer body including laminated dielectric layers, inner electrode layers laminated on the dielectric layers, first and second inner electrode layer, a first outer electrode on a first end surface of the multilayer body and connected to the first inner electrode layer, a second outer electrode on a second end surface of the multilayer body and connected to the first inner electrode layer, a third outer electrode on a first side surface of the multilayer body and connected to the second inner electrode layer, and a fourth outer electrode on a second side surface of the multilayer body and connected to the second inner electrode layer. The first outer electrode includes a first plating layer and a first charging electrode, and the second outer electrode includes a second plating layer and a second charging electrode.

### CROSS REFERENCE TO RELATED APPLICATIONS

This application is a Continuation Application of PCT Application No. PCT/JP2023/013546, filed on Mar. 31, 2023, and claims the benefit of priority to Japanese Patent Application No. 2022-102339, filed on Jun. 27, 2022. The entire contents of each application are hereby incorporated herein by reference.

### BACKGROUND OF THE INVENTION

### 1. Field of the Invention

The present invention relates to through-type multilayer ceramic capacitors.

### 2. Description of the Related Art

For example, a through-type multilayer ceramic capacitor having a structure as described in Japanese Unexamined Patent Application Publication No. 2000-58376 is known as a decoupling capacitor used to stabilize a power voltage supplied to an integrated circuit component (IC) that operates at a high speed, or as a noise countermeasure component for a power line.

The through-type multilayer ceramic capacitor described in Japanese Unexamined Patent Application Publication No. 2000-58376 has a general structure and includes a ceramic base (multilayer body) having an outer surface including first and second main surfaces opposing each other, first and second side surfaces opposing each other, and first and second end surfaces opposing each other. A plurality of first and second inner electrodes are alternately located inside the ceramic base in a lamination direction. Two ends of the first inner electrode extend to the first and second end surfaces, and two ends of the second inner electrode extend to the first and second side surfaces. Moreover, a first terminal electrode is provided at one end of the ceramic base, and is connected to one end of the first inner electrode. In addition, a second terminal electrode is provided at the other end of the ceramic base, and is connected to the other end of the first inner electrode. Further, a third terminal electrode is provided in an intermediate portion of the ceramic base and is connected to the second inner electrode.

In recent years, miniaturization of electronic devices, such as mobile phones and portable music players, has been advanced. In accordance with this, the ceramic electronic component mounted in the downsized electronic device is also downsized, and a demand for downsizing of the through-type multilayer ceramic capacitor as described in Japanese Unexamined Patent Application Publication No. 2000-58376 has been increased.

However, in the through-type multilayer ceramic capacitor as in Japanese Unexamined Patent Application Publication No. 2000-58376, in a case where the size is further reduced, not only a distance between the first terminal electrode and the third terminal electrode of the through-type multilayer ceramic capacitor or a distance between the second terminal electrode and the third terminal electrode is shortened, but also the control of coating of the inner electrode or the outer electrode is difficult. As a result, there is a concern that a short circuit defect or electrochemical migration may occur.

### SUMMARY OF THE INVENTION

Example embodiments of the present invention provide through-type multilayer ceramic capacitors each able to avoid an approach between a plurality of outer electrodes located in a multilayer body while avoiding inconvenience in manufacturing due to miniaturization of such through-type multilayer ceramic capacitors.

According to an example embodiment of the present invention, a through-type multilayer ceramic capacitor includes a multilayer body including a plurality of dielectric layers that are laminated, and a plurality of inner electrode layers laminated on the dielectric layers, the multilayer body including a first main surface and a second main surface which oppose each other in a lamination direction, a first side surface and a second side surface which oppose each other in a width direction orthogonal or substantially orthogonal to the lamination direction, a first end surface and a second end surface which oppose each other in a length direction orthogonal or substantially orthogonal to the lamination direction and the width direction, a first inner electrode layer among the plurality of inner electrode layers extending to the first end surface and the second end surface, a second inner electrode layer among the plurality of inner electrode layers extending to the first side surface and the second side surface, a first outer electrode on the first end surface and connected to the first inner electrode layer, a second outer electrode on the second end surface and connected to the first inner electrode layer, a third outer electrode on the first side surface and connected to the second inner electrode layer, and a fourth outer electrode on the second side surface and connected to the second inner electrode layer. The first outer electrode includes a first plating layer on the first end surface, and a first charging electrode on the first end surface and having a length shorter than a length of the first plating layer in the width direction. The second outer electrode includes a second plating layer on the second end surface, and a second charging electrode on the second end surface and having a length shorter than a length of the second plating layer in the width direction. The third outer electrode includes a third plating layer on the first side surface, and a third charging electrode on the first side surface and having a length shorter than a length of the third plating layer in the length direction. The fourth outer electrode includes a fourth plating layer on the second side surface, and a fourth charging electrode on the second side surface and having a length shorter than a length of the fourth plating layer in the length direction.

In the through-type multilayer ceramic capacitor according to example embodiments of the present invention, the first outer electrode includes the first plating layer on the first end surface, and the first charging electrode on the first end surface and having a length shorter than a length of the first plating layer in the width direction, the second outer electrode includes the second plating layer on the second end surface, and the second charging electrode on the second end surface and having a length shorter than a length of the second plating layer in the width direction, the third outer electrode includes the third plating layer on the first side surface, and the third charging electrode on the first side surface and having a length shorter than a length of the third plating layer in the length direction, and the fourth outer electrode includes the fourth plating layer on the second side surface, and the fourth charging electrode on the second side surface and having length shorter than a length of the fourth plating layer in the length direction. Therefore, since the first outer electrode and the second outer electrode do not wrap around the first side surface and the second side surface, a distance between the first outer electrode and the second outer electrode and the third outer electrode can be sufficiently ensured, and a distance between the first outer electrode and the second outer electrode and the fourth outer electrode can be sufficiently ensured. Therefore, in the through-type multilayer ceramic capacitor, an occurrence of short circuit defects or electrochemical migration are able to be reduced or prevented.

In addition, in a through-type multilayer ceramic capacitor according to an example embodiment of the present invention, since the first outer electrode to the fourth outer electrode have the above-described configurations, it is not necessary to narrow the width of the first inner electrode layer extending to the first end surface and the second end surface and the width of the second inner electrode layer extending to the first side surface and the second side surface. As a result, since a state in which a width of a first extended electrode portion and a width of a second extended electrode portion of the first inner electrode layer are sufficiently ensured and a width of a third extended electrode portion and a width of a fourth extended electrode portion of the second inner electrode layer are sufficiently ensured are able to be maintained, control of printing on a coating surface of the inner electrode layer is facilitated, and deterioration of an equivalent series resistance (ESL) and a direct current resistance (Rdc) are able to be reduced or prevented.

According to example embodiments of the present invention, it is possible to provide through-type multilayer ceramic capacitors each able to avoid an approach between a plurality of outer electrodes located in a multilayer body while avoiding manufacturing inconvenience due to miniaturization of the through-type multilayer ceramic capacitors.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating an example of a through-type multilayer ceramic capacitor according to a first example embodiment of the present invention.

FIG. 2 is a top view illustrating an example of the through-type multilayer ceramic capacitor according to the first example embodiment of the present invention.

FIG. 3 is a front view illustrating an example of the through-type multilayer ceramic capacitor according to the first example embodiment of the present invention.

FIG. 4 is an external perspective view illustrating a state in which a plating layer and a charging electrode are located in a multilayer body of the through-type multilayer ceramic capacitor according to the first example embodiment of the present invention.

FIG. 5 is a cross-sectional view taken along line V-V in FIG. 1.

FIG. 6 is a cross-sectional view taken along line VI-VI in FIG. 1.

FIG. 7 is a cross-sectional view taken along line VII-VII in FIG. 5.

FIG. 8 is a cross-sectional view taken along line VIII-VIII in FIG. 5.

FIG. 9 is an external perspective view illustrating an example of a through-type multilayer ceramic capacitor according to a second example embodiment of the present invention.

FIG. 10 is an external perspective view illustrating a state in which a plating layer and a charging electrode are located in a multilayer body of the through-type multilayer ceramic capacitor according to the second example embodiment of the present invention.

FIG. 11 is a cross-sectional view taken along line XI-XI in FIG. 9.

FIG. 12 is a cross-sectional view taken along line XII-XII in FIG. 9.

FIG. 13 is a cross-sectional view taken along line XIII-XIII in FIG. 11.

FIG. 14 is a cross-sectional view taken along line XIV-XIV in FIG. 11.

### DETAILED DESCRIPTION OF THE EXAMPLE EMBODIMENTS

Example embodiments of the present invention will be described below with reference to the drawings.

### A. First Example Embodiment

### 1. Through-Type Multilayer Ceramic Capacitor

A through-type multilayer ceramic capacitor according to a first example embodiment of the present invention will be described.

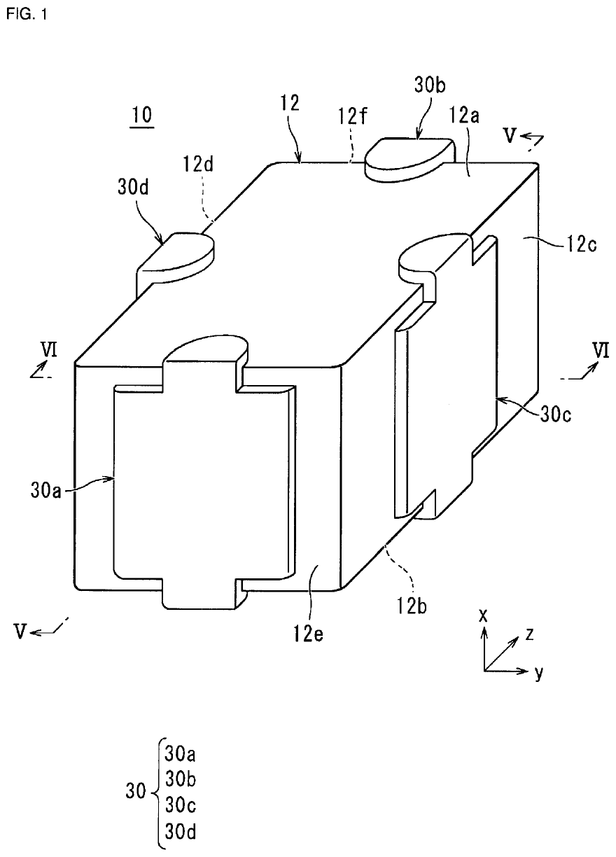

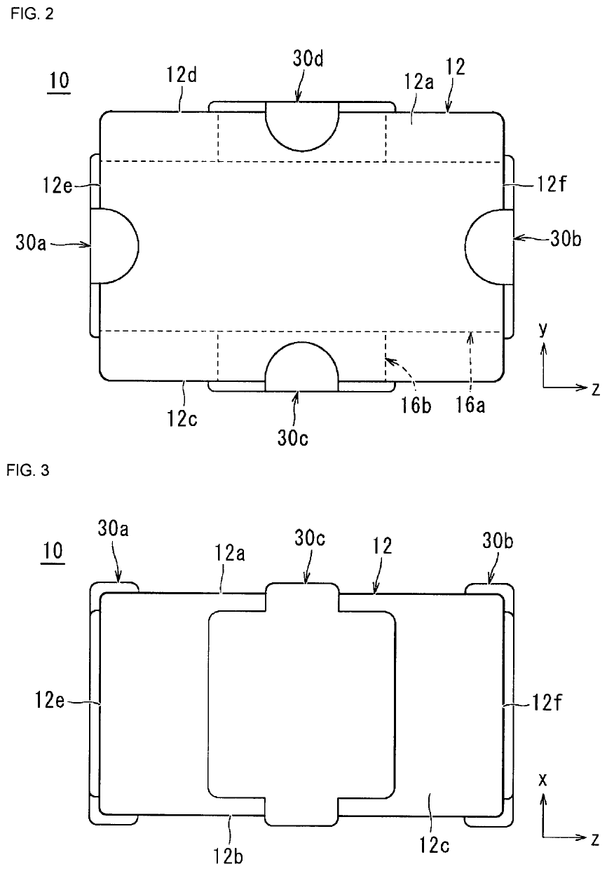

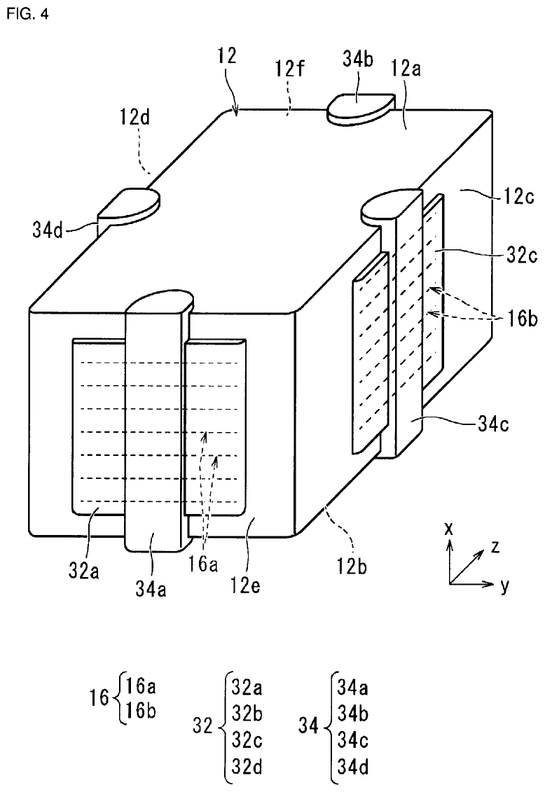

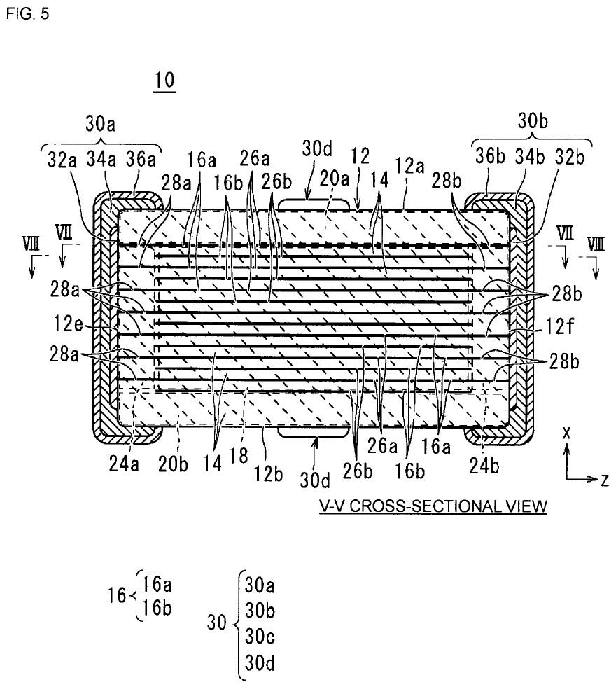

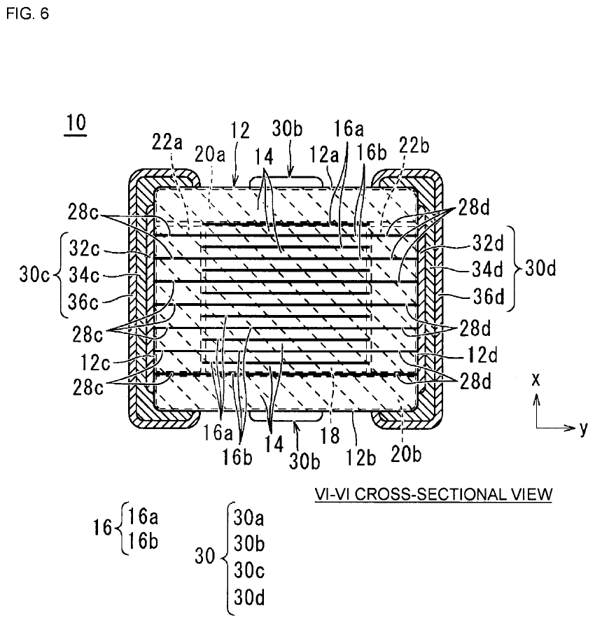

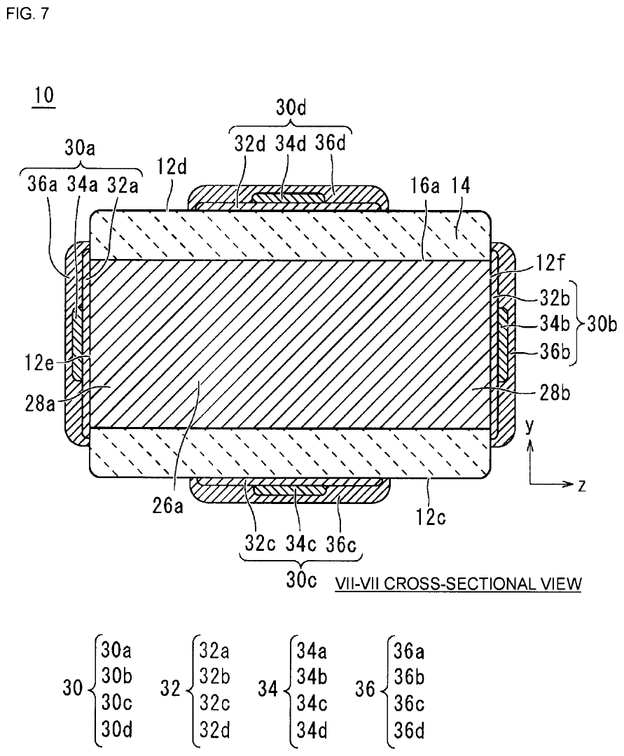

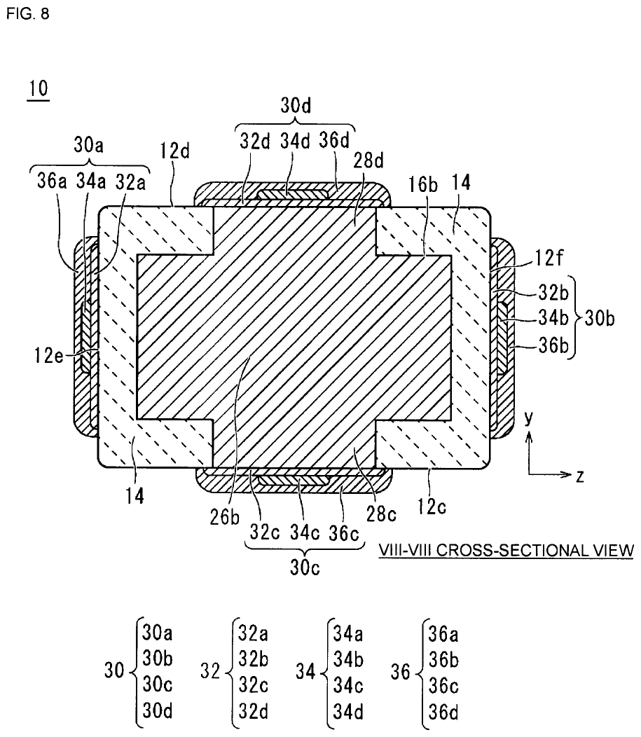

FIG. 1 is an external perspective view illustrating an example of a through-type multilayer ceramic capacitor according to the first example embodiment of the present invention. FIG. 2 is a top view illustrating an example of the through-type multilayer ceramic capacitor according to the first example embodiment of the present invention. FIG. 3 is a front view illustrating an example of the through-type multilayer ceramic capacitor according to the first example embodiment of the present invention. FIG. 4 is an external perspective view illustrating a state in which a plating layer and a charging electrode are located in a multilayer body of the through-type multilayer ceramic capacitor according to the first example embodiment of the present invention. FIG. 5 is a cross-sectional view taken along line V-V in FIG. 1. FIG. 6 is a cross-sectional view taken along line VI-VI in FIG. 1. FIG. 7 is a cross-sectional view taken along line VII-VII in FIG. 5. FIG. 8 is a cross-sectional view taken along line VIII-VIII in FIG. 5.

As illustrated in FIG. 1, the through-type multilayer ceramic capacitor 10 includes a multilayer body 12 and an outer electrode 30.

### (1) Multilayer Body

The multilayer body 12 includes a plurality of laminated dielectric layers 14 and a plurality of inner electrode layers 16 laminated on the dielectric layers 14. The dielectric layer 14 and the inner electrode layer 16 are laminated in a lamination direction x.

The multilayer body 12 preferably has a rectangular or substantially rectangular parallelepiped shape. The multilayer body 12 includes a first main surface 12a and a second main surface 12b opposing each other in the lamination direction x, a first side surface 12c and a second side surface 12d opposing each other in a width direction y orthogonal or substantially orthogonal to the lamination direction x, and a first end surface 12e and a second end surface 12f opposing each other in a length direction z orthogonal to the lamination direction x and the width direction y. The dimension of the multilayer body 12 in the length direction z is not necessarily longer than the dimension in the width direction y. The multilayer body 12 has rounded corner portions and ridge portions. The corner portion is a portion where three adjacent surfaces of the multilayer body intersect with each other, and the ridge portion is a portion where two adjacent surfaces of the multilayer body intersect with each other. In addition, unevenness or the like may be provided on some or all of the first main surface 12a, the second main surface 12b, the first side surface 12c, the second side surface 12d, the first end surface 12e, and the second end surface 12f.

The multilayer body 12 includes an inner layer portion 18 including one or a plurality of dielectric layers 14 and a plurality of inner electrode layers 16 located thereon. The inner layer portion 18 is defined by a region from the inner electrode layer 16 positioned closest to the first main surface 12a side to the inner electrode layer 16 positioned closest to the second main surface 12b side in the lamination direction x. The inner electrode layer 16 includes a first inner electrode layer 16a extending to the first end surface 12e and the second end surface 12f and a second inner electrode layer 16b that is extended to the first side surface 12c and the second side surface 12d, and in the inner layer portion 18, a plurality of the first inner electrode layers 16a and the second inner electrode layers 16b oppose each other with the dielectric layer 14 interposed therebetween. The inner layer portion 18 is a portion that generates an electrostatic capacity and substantially functions as a capacitor.

The multilayer body 12 includes a first main surface-side outer layer portion 20a, which is positioned on the first main surface 12a side, and includes a plurality of the dielectric layers 14 positioned between the first main surface 12a, an outermost surface of the inner layer portion 18 on the first main surface 12a side, and on a straight line of the outermost surface thereof. Similarly, the multilayer body 12 includes a second main surface-side outer layer portion 20b, which is positioned on the second main surface 12b side and includes a plurality of the dielectric layers 14 positioned between the second main surface 12b, an outermost surface of the inner layer portion 18 on the second main surface 12b side, and on a straight line of the outermost surface thereof.

In addition, the multilayer body 12 includes a first side surface-side outer layer portion 22a, which is positioned on the first side surface 12c side and includes a plurality of dielectric layers 14 positioned between the first side surface 12c and an outermost surface of the inner layer portion 18 on the first side surface 12c side.

Similarly, the multilayer body 12 includes a second side surface-side outer layer portion 22b, which is positioned on the second side surface 12d side and includes a plurality of the dielectric layers 14 positioned between the second side surface 12d and an outermost surface of the inner layer portion 18 on the second side surface 12d side.

In addition, the multilayer body 12 includes a first end surface-side outer layer portion 24a, which is positioned on the first end surface 12e side and includes the plurality of dielectric layers 14 positioned between the first end surface 12e and an outermost surface of the inner layer portion 18 on the first end surface 12e side.

Similarly, the multilayer body 12 includes a second end surface-side outer layer portion 24b, which is positioned on the second end surface 12f side and includes of a plurality of the dielectric layers 14 positioned between the second end surface 12f and an outermost surface of the inner layer portion 18 on the second end surface 12f side.

The first main surface-side outer layer portion 20a is positioned on the first main surface 12a side. The first main surface-side outer layer portion 20a is an aggregate of a plurality of dielectric layers 14 positioned between the first main surface 12a and the inner electrode layer 16 closest to the first main surface 12a. The dielectric layer 14 used in the first main surface-side outer layer portion 20a may be the same as the dielectric layer 14 used in the inner layer portion 18.

The second main surface-side outer layer portion 20b is positioned on the second main surface 12b side. The second main surface-side outer layer portion 20b is an aggregate of a plurality of dielectric layers 14 positioned between the second main surface 12b and the inner electrode layer 16 closest to the second main surface 12b. The dielectric layer 14 used in the second main surface-side outer layer portion 20b may be the same as the dielectric layer 14 used in the inner layer portion 18.

The multilayer body 12 includes an opposing electrode portion 19. The opposing electrode portion 19 is a portion where a first opposing electrode portion 26a of a first inner electrode layer 16a, which will be described later, and a second opposing electrode portion 26b of a second inner electrode layer 16b, which will be described later, oppose each other. The opposing electrode portion 19 is configured as a portion of the inner layer portion 18. The opposing electrode portion 19 is also referred to as a capacitor effective portion.

The first side surface-side outer layer portion 22a is a portion including the dielectric layer 14 positioned between the opposing electrode portion 19 and the first side surface 12c.

The second side surface-side outer layer portion 22b is a portion including the dielectric layer 14 that is positioned between the opposing electrode portion 19 and the second side surface 12d.

In addition, the first side surface-side outer layer portion 22a and the second side surface-side outer layer portion 22b are also referred to as a W gap or a side gap.

The first end surface-side outer layer portion 24a is a portion including the dielectric layer 14 positioned between the opposing electrode portion 19 and the first end surface 12e.

The second end surface-side outer layer portion 24b is a portion including the dielectric layer 14 positioned between the opposing electrode portion 19 and the second end surface 12f.

In addition, the first end surface-side outer layer portion 24a and the second end surface-side outer layer portion 24b are also referred to as an L gap or an end gap.

The dimensions of the multilayer body 12 are not particularly limited.

The dielectric layer 14 can be made of a dielectric material, for example, as a ceramic material. As such a dielectric material, for example, a dielectric ceramic including a component such as BaTiO₃, CaTiO₃, SrTiO₃, or CaZro₃ can be used. When the dielectric material is included as a main component, a secondary component having a lower content than a main component such as, for example, a Mn compound, an Fe compound, a Cr compound, a Co compound or a Ni compound may be added according to the desired characteristics of the multilayer body 12.

A thickness of the dielectric layer 14 after firing is, for example, preferably about 0.30 μm or more and about 2.0 μm or less. The number of dielectric layers 14 to be laminated is, for example, preferably 15 or more and 1000 or less. The number of dielectric layers 14 is the total number of the dielectric layers 14 in the inner layer portion 18 and the dielectric layers 14 in the first main surface-side outer layer portion 20a and the second main surface-side outer layer portion 20b.

The multilayer body 12 includes a plurality of first inner electrode layers 16a and a plurality of second inner electrode layers 16b as the plurality of inner electrode layers 16. The plurality of first inner electrode layers 16a and the plurality of second inner electrode layers 16b are embedded to be alternately and equally spaced along the lamination direction x of the multilayer body 12 with the dielectric layer 14 interposed therebetween.

As illustrated in FIG. 7, the first inner electrode layer 16a includes the first opposing electrode portion 26a opposing the second inner electrode layer 16b with the dielectric layer 14 interposed therebetween, and a first extended electrode portion 28a extended from the first opposing electrode portion 26a to the surface of the first end surface 12e of the multilayer body 12 and a second extended electrode portion 28b extended from the first opposing electrode portion 26a to the surface of the second end surface 12f of the multilayer body 12. Specifically, the first extended electrode portion 28a is exposed on the surface of the first end surface 12e of the multilayer body 12, and the second extended electrode portion 28b is exposed on the surface of the second end surface 12f of the multilayer body 12. Therefore, the first inner electrode layer 16a is not exposed on the surfaces of the first side surface 12c and the second side surface 12d of the multilayer body 12.

The shape of the first opposing electrode portion 26a, and the shapes of the first extended electrode portion 28a and the second extended electrode portion 28b are not particularly limited, but are, for example, preferably a short rectangle. However, the shape of the first opposing electrode portion 26a and the corner portions of the first extended electrode portion 28a and the second extended electrode portion 28b may be rounded.

In addition, the lengths of the first extended electrode portion 28a and the second extended electrode portion 28b may have the same or substantially the same length as the length of the first opposing electrode portion 26a in the width direction y, or may have a length shorter than the length of the first opposing electrode portion 26a in the width direction y.

In addition, the shape of the first extended electrode portion 28a may have a tapered shape such that the length in the width direction y thereof is narrowed toward the first end surface 12e, and the shape of the second extended electrode portion 28b may have a tapered shape such that the length in the length direction z thereof is narrowed toward the second end surface 12f.

As illustrated in FIG. 8, the second inner electrode layer 16b has a cross or substantially cross shape, and includes a second opposing electrode portion 26b opposing the first inner electrode layer 16a with the dielectric layer 14 interposed therebetween, a third extended electrode portion 28c extended from the second opposing electrode portion 26b to the surface of the first side surface 12c of the multilayer body 12, and a fourth extended electrode portion 28d extended from the second opposing electrode portion 26b to the surface of the second side surface 12d of the multilayer body 12. Specifically, the third extended electrode portion 28c is exposed on the surface of the first side surface 12c of the multilayer body 12, and the fourth extended electrode portion 28d is exposed on the surface of the second side surface 12d of the multilayer body 12. Therefore, the second inner electrode layer 16b is not exposed on the surface of the first end surface 12e and the surface of the second end surface 12f of the multilayer body 12.

The shape of the second opposing electrode portion 26b, and the shapes of the third extended electrode portion 28c and the fourth extended electrode portion 28d are not particularly limited, but are, for example, preferably a short rectangle. However, the shape of the second opposing electrode portion 26b and the corner portions of the third extended electrode portion 28c and the fourth extended electrode portion 28d may be rounded.

A relationship between a dimension A in the length direction z connecting a side on the first end surface 12e side and a side on the second end surface 12f side of the second opposing electrode portion 26b and a dimension B in the length direction z connecting a side on the first end surface 12e side and a side on the second end surface 12f side of the third extended electrode portion 28c and the fourth extended electrode portion 28d is preferably A≥B.

In addition, the shape of the third extended electrode portion 28c may have a tapered shape such that the length in the length direction z thereof is narrowed toward the first side surface 12c, and the shape of the fourth extended electrode portion 28d may have a tapered shape such that the length in the length direction z thereof is narrowed toward the second side surface 12d.

The first inner electrode layer 16a and the second inner electrode layer 16b may be alternately laminated with the dielectric layer 14 interposed therebetween, or a plurality of dielectric layers 14 in which the first inner electrode layer 16a is provided may be laminated, and then the dielectric layer 14 in which the second inner electrode layer 16b is disposed may be laminated. In this manner, the lamination pattern of the inner electrode layer 16 can be changed according to the desired capacitance value.

The first inner electrode layer 16a and the second inner electrode layer 16b can be formed of appropriate conductive materials such as, for example, a metal such as Ni, Cu, Ag, Pd, and Au, or an alloy including at least one of these metals, such as Ag—Pd alloy and the like, for example.

Sn may be present at the interface between the dielectric layer 14 and the inner electrode layer 16. In a case where Sn is present at the interface between the dielectric layer 14 and the inner electrode layer 16, Sn may be present in a laminated form parallel to the inner electrode layer 16, or may be present in a scattered form. In addition, the Sn may be solid-solubilized in the inner electrode layer 16 or may be present in the dielectric layer 14.

The total number of the first inner electrode layers 16a and the second inner electrode layers 16b is, for example, preferably 15 sheets or more and 500 sheets or less.

A thickness of the first inner electrode layer 16a is, for example, preferably about 0.3 μm or more and about 1.0 μm or less.

A thickness of the second inner electrode layer 16b is, for example, preferably about 0.3 μm or more and about 1.0 μm or less.

### (2) Outer Electrode

The outer electrodes 30 are located on the first end surface 12e side and the second end surface 12f side of the multilayer body 12, and on the first side surface 12c side and the second side surface 12d side.

The outer electrode 30 includes a plating layer 32 and a charging electrode 34. In addition, the outer electrode 30 preferably includes an upper plating layer 36 that covers the plating layer 32 and the charging electrode 34. The upper plating layer 36 in the outer electrode 30 does not necessarily need to be included.

The outer electrode 30 includes a first outer electrode 30a, a second outer electrode 30b, a third outer electrode 30c, and a fourth outer electrode 30d.

The first outer electrode 30a is located on the first end surface 12e and is connected to the first inner electrode layer 16a. The first outer electrode 30a preferably includes a first plating layer 32a located on the first end surface 12e and a first charging electrode 34a located on the first end surface 12e and having a length shorter than the length of the first plating layer 32a in the width direction y. In this case, the first outer electrode 30a is electrically connected to the first extended electrode portion 28a of the first inner electrode layer 16a.

The second outer electrode 30b is located on the second end surface 12f and is connected to the first inner electrode layer 16a. The second outer electrode 30b preferably includes a second plating layer 32b located on the second end surface 12f and a second charging electrode 34b located on the second end surface 12f and having a length shorter than the length of the second plating layer 32b in the width direction y. In this case, the second outer electrode 30b is electrically connected to the second extended electrode portion 28b of the first inner electrode layer 16a.

The third outer electrode 30c is located on the first side surface 12c and is connected to the second inner electrode layer 16b. The third outer electrode 30c preferably includes a third plating layer 32c located on the first side surface 12c, and a third charging electrode 34c located on the first side surface 12c and having a length shorter than a length of the third plating layer 32c in the length direction z. In this case, the third outer electrode 30c is electrically connected to the third extended electrode portion 28c of the second inner electrode layer 16b.

The fourth outer electrode 30d is located on the second side surface 12d and is connected to the second inner electrode layer 16b. The fourth outer electrode 30d preferably includes a fourth plating layer 32d located on the second side surface 12d and a fourth charging electrode 34d located on the second side surface 12d and having a length shorter than a length of the fourth plating layer 32d in the length direction z. In this case, the fourth outer electrode 30d is electrically connected to the fourth extended electrode portion 28d of the second inner electrode layer 16b.

In the multilayer body 12, the first opposing electrode portion 26a of the first inner electrode layer 16a and the second opposing electrode portion 26b of the second inner electrode layer 16b oppose each other with the dielectric layer 14 interposed therebetween to form electrostatic capacity. Therefore, electrostatic capacity can be obtained between the first outer electrode 30a and the second outer electrode 30b to which the first inner electrode layer 16a is connected and the third outer electrode 30c and the fourth outer electrode 30d to which the second inner electrode layer 16b is connected, and characteristics of the capacitor are provided.

The first plating layer 32a covers the first inner electrode layer 16a, and the first charging electrode 34a is located on the surfaces of the first plating layer 32a and the first end surface 12e.

The second plating layer 32b covers the first inner electrode layer 16a, and the second charging electrode 34b is located on the surfaces of the second plating layer 32b and the second end surface 12f.

The third plating layer 32c covers the second inner electrode layer 16b, and the third charging electrode 34c is located on the surfaces of the third plating layer 32c and the first side surface 12c.

The fourth plating layer 32d covers the second inner electrode layer 16b, and the fourth charging electrode 34d is located on the surfaces of the fourth plating layer 32d and the second side surface 12d.

As illustrated in FIG. 4, the plating layer 32 covers the inner electrode layer 16 exposed on the surface of the multilayer body 12.

The first plating layer 32a covers the first inner electrode layer 16a which is extended to and exposed on the first end surface 12e. At this time, the first plating layer 32a directly covers the first extended electrode portion 28a of the first inner electrode layer 16a exposed on the first end surface 12e. The first plating layer 32a is continuously and directly located on the dielectric layer 14 (that is, on the surface of the multilayer body 12) positioned between the plurality of first inner electrode layers 16a exposed on the first end surface 12e.

The second plating layer 32b covers the first inner electrode layer 16a which is extended to and exposed on the second end surface 12f. At this time, the second plating layer 32b directly covers the second extended electrode portion 28b of the first inner electrode layer 16a exposed on the second end surface 12f. The second plating layer 32b is continuously and directly located on the dielectric layer 14 (that is, on the surface of the multilayer body 12) positioned between the plurality of first inner electrode layers 16a exposed on the second end surface 12f.

The third plating layer 32c covers the second inner electrode layer 16b which is extended to and exposed on the first side surface 12c. At this time, the third plating layer 32c directly covers the third extended electrode portion 28c of the second inner electrode layer 16b exposed on the first side surface 12c. The third plating layer 32c is continuously and directly located on the dielectric layer 14 (that is, on the surface of the multilayer body 12) positioned between the plurality of second inner electrode layers 16b exposed on the first side surface 12c.

The fourth plating layer 32d covers the second inner electrode layer 16b which is extended to and exposed on the second side surface 12d. At this time, the fourth plating layer 32d directly covers the fourth extended electrode portion 28d of the second inner electrode layer 16b exposed on the second side surface 12d. The fourth plating layer 32d is continuously and directly located on the dielectric layer 14 (that is, on the surface of the multilayer body 12) positioned between the plurality of second inner electrode layers 16b exposed on the second side surface 12d.

The plating layer 32 preferably includes, for example, at least one of Cu, Ni, Sn, Ag, Pd, Ag-Pd alloy, Au, and the like. Among these, for example, the plating layer 32 is preferably a Cu plating layer. As a result, it is possible to effectively reduce or prevent the plating liquid or the moisture from entering the inside of the multilayer body 12.

The metal of the first inner electrode layer 16a and the metal of the second inner electrode layer 16b may diffuse into the first plating layer 32a to the fourth plating layer 32d.

The lengths of the first plating layer 32a and the second plating layer 32b in the width direction y are smaller than the length of the multilayer body 12 in the width direction y.

The lengths of the first plating layer 32a and the second plating layer 32b in the lamination direction x are smaller than the length of the multilayer body 12 in the lamination direction x.

The lengths of the third plating layer 32c and the fourth plating layer 32d in the length direction z are smaller than the length of the multilayer body 12 in the length direction z.

The lengths of the third plating layer 32c and the fourth plating layer 32d in the lamination direction x are smaller than the length of the multilayer body 12 in the lamination direction x.

As a result, the first to fourth plating layers 32a to 32d can be located in the in-plane of the end surfaces 12e and 12f and the side surfaces 12c and 12d of the multilayer body 12, and the distance between the first outer electrode 30a and the second outer electrode 30b and the third outer electrode 30c, and the distance between the first outer electrode 30a and the second outer electrode 30b and the fourth outer electrode 30d can be sufficiently secured, so that the occurrence of short circuit defects and electrochemical migration can be more effectively reduced or prevented.

The first plating layer 32a to the fourth plating layer 32d may include a plurality of layers.

The thickness of each of the first plating layer 32a to the fourth plating layer 32d per layer is, for example, preferably about 2 μm or more and about 30 μm or less.

As illustrated in FIG. 4, the charging electrode 34 is located on the surface of the plating layer 32 located on the surface of the multilayer body 12.

The first charging electrode 34a is located on the surface of the first plating layer 32a located on the first end surface 12e. The length of the first charging electrode 34a in the width direction y is shorter than the length of the first plating layer 32a in the width direction y.

The second charging electrode 34b is located on the surface of the second plating layer 32b located on the second end surface 12f. The length of the second charging electrode 34b in the width direction y is shorter than the length of the second plating layer 32b in the width direction y.

The third charging electrode 34c is located on a surface of the third plating layer 32c located on the first side surface 12c. The length of the third charging electrode 34c in the length direction z is shorter than a length of the third plating layer 32c in the length direction z.

The fourth charging electrode 34d is located on a surface of the fourth plating layer 32d located on the second side surface 12d. The length of the fourth charging electrode 34d in the length direction y is shorter than a length of the fourth plating layer 32d in the length direction z.

It is preferable that the first charging electrode 34a to the fourth charging electrode 34d are each disposed to extend to a portion of the first main surface 12a and a portion of the second main surface 12b.

That is, it is preferable that the first charging electrode 34a extends from the first end surface 12e and is also located on a portion of the first main surface 12a and a portion of the second main surface 12b, the second charging electrode 34b extends from the second end surface 12f and is also located on a portion of the first main surface 12a and a portion of the second main surface 12b, the third charging electrode 34c extends from the first side surface 12c and is also located on a portion of the first main surface 12a and a portion of the second main surface 12b, and the fourth charging electrode 34d extends from the second side surface 12d and is also located on a portion of the first main surface 12a and a portion of the second main surface 12b.

As result, the through-type multilayer ceramic capacitor 10 can be easily and stably mounted on the mounting substrate.

The lengths of the first and second charging electrodes 34a and 34b in the width direction y are, for example, preferably about 20% or more and about 95% or less with respect to the lengths of the first and second plating layers 32a and 32b in the width direction y.

In addition, the lengths of the third charging electrode 34c and the fourth charging electrode 34d in the length direction z is, for example, preferably about 10% or more and about 95% or less with respect to the lengths of the third plating layer 32c and the fourth plating layer 32d in the length direction z.

As a result, mounting property of the through-type multilayer ceramic capacitor 10 on the mounting substrate can be sufficiently ensured.

Here, an example of a measurement method of the lengths of the first plating layer 32a and the second plating layer 32b along the width direction y and the lengths of the third plating layer 32c and the fourth plating layer 32d along the length direction z will be described.

In the example measurement method of the lengths of the first plating layer 32a and the second plating layer 32b along the width direction y, and the measurement method of the length of the third plating layer 32c and the fourth plating layer 32d along the length direction z, first, the polishing is performed to a position at ½T in the lamination direction x of the through-type multilayer ceramic capacitor 10, so that the first main surface 12a or the second main surface 12b is substantially parallel to the polished surface, and the LW surface, which is the polished surface, is exposed.

Thereafter, in the exposed polished surface, that is, the LW surface, the lengths of the first plating layer 32a and the second plating layer 32b along the width direction y and the lengths of the third plating layer 32c and the fourth plating layer 32d along the length direction z are measured using a microscope, and the measurement results are defined as the lengths of the first plating layer 32a and the second plating layer 32b along the width direction y and the lengths of the third plating layer 32c and the fourth plating layer 32d along the length direction z.

In addition, the measurement method of the lengths of the first charging electrode 34a and the second charging electrode 34b along the width direction y and the lengths of the third charging electrode 34c and the fourth charging electrode 34d along the length direction z will be described.

In the measurement method of the lengths of the first charging electrode 34a and the second charging electrode 34b along the width direction y and the measurement method of the lengths of the third charging electrodes 34c and the fourth charging electrode 34d along the length direction z, first, polishing is performed to be parallel or substantially parallel to the first main surface 12a or the second main surface 12b to the position of ½T of the through-type multilayer ceramic capacitor 10 in the lamination direction x, and the LW surface, which is a polished surface, is exposed.

Thereafter, in the exposed polished surface, that is, the LW surface, the lengths of the first charging electrode 34a and the second charging electrode 34b along the width direction y and the lengths of the third charging electrode 34c and the fourth charging electrode 34d along the length direction z are measured using a microscope, and the measured results are defined as the lengths of the first charging electrode 34a and the second charging electrode 34b along the width direction y and the lengths of the third charging electrode 34c and the fourth charging electrode 34d along the length direction z.

The charging electrode 34 includes at least one selected from a baked layer, a conductive resin layer, or a thin film layer.

Hereinafter, each configuration in a case where the charging electrode 34 is used as the above-described baked layer, conductive resin layer, and thin film layer will be described.

### In Case of Baked Layer

In the present example embodiment, the charging electrode 34 is, for example, preferably a baked layer.

The baked layer includes a glass component and a metal component. The glass component of the baked layer preferably includes, for example, at least one of B, Si, Ba, Mg, Al, Li, and the like.

The metal component of the baked layer preferably includes, for example, at least one of Cu, Ni, Ag, Pd, an Ag-Pd alloy, Au, and the like. The baked layer may include a plurality of layers. The baked layer is obtained by applying a conductive paste including a glass component and a metal component to the multilayer body 12 and performing a baking treatment. The baked layer may be a layer obtained by simultaneously firing a multilayer chip having the inner electrode layer 16 and the dielectric layer 14 and a conductive paste applied to the multilayer chip, or may be a layer obtained by applying and firing the conductive paste to a multilayer body 12 after obtaining the multilayer body 12 by baking the multilayer chip having the inner electrode layer 16 and the dielectric layer 14. In the baked layer, when the multilayer chip including the inner electrode layer 16 and the dielectric layer 14 and the conductive paste applied to the multilayer chip are simultaneously fired, it is preferable that the baked layer is formed by baking a layer in which the dielectric material is added instead of the glass component.

The baked layer may include a plurality of layers.

A thickness of the first end surface 12e and the second end surface 12f connected to each other in the length direction z at the central portion of the first charging electrode 34a positioned on the first end surface 12e in the lamination direction x is, for example, preferably about 3 μm or more and about 70 μm or less.

A thickness of the first end surface 12e and the second end surface 12f connected to each other in the length direction z at the central portion of the second charging electrode 34b positioned on the second end surface 12f in the lamination direction x, is, for example, preferably about 3 μm or more and about 70 μm or less.

A thickness of the first main surface 12a and the second main surface 12b connected to each other in the lamination direction x at the central portion of the length direction z connecting the first end surface 12e and the second end surface 12f of the first charging electrode 34a positioned on a portion of the first main surface 12a and the second main surface 12b is, for example, preferably about 3 μm or more and about 40 μm or less.

In addition, a thickness of the first main surface 12a and the second main surface 12b connected to each other in the lamination direction x at the central portion of the length direction z connecting the first end surface 12e and the second end surface 12f of the second charging electrode 34b positioned in a portion of the first main surface 12a and the second main surface 12b is, for example, preferably about 3 μm or more and about 40 μm or less.

A thickness of the first side surface 12c and the second side surface 12d connected to each other in the width direction y at the central portion in the length direction z connecting the first end surface 12e and the second end surface 12f of the first charging electrode 34a positioned in a portion of the first side surface 12c and the second side surface 12d is, for example, preferably about 3 μm or more and about 40 μm or less.

In addition, a thickness of the first side surface 12c and the second side surface 12d connected to each other in the width direction y at the central portion in the length direction z connecting the first end surface 12e and the second end surface 12f of the second charging electrode 34b positioned in a portion of the first side surface 12c and the second side surface 12d is, for example, preferably about 3 μm or more and about 40 μm or less.

### In Case of Conductive Resin Layer

In a case where the conductive resin layer is provided as the charging electrode 34, the conductive resin layer may cover the baked layer on the baked layer, or may be directly located on the plating layer 32 and the multilayer body 12.

The conductive resin layer preferably includes, for example, a metal and a thermosetting resin.

Since the conductive resin layer includes a thermosetting resin, for example, the conductive resin layer has more flexibility than a conductive layer including a plating film or a fired product of a conductive paste. Therefore, even when a physical impact or an impact caused by a thermal cycle is applied to the through-type multilayer ceramic capacitor 10, the conductive resin layer defines and functions as a buffer layer, and it is possible to prevent cracks from occurring in the through-type multilayer ceramic capacitor 10.

As the metal included in the conductive resin layer, for example, Ag, Cu, Ni, Sn, Bi, or an alloy including these metals can preferably be used.

In addition, for example, a metal powder whose surface is coated with Ag can also be used. In a case of using the metal powder whose surface is coated with Ag, it is preferable to use, for example, Cu, Ni, Sn, Bi, or an alloy powder thereof as the metal powder. The reason for using the conductive metal powder of Ag for the conductive metal is that Ag is suitable for an electrode material because Ag has the lowest specific resistance among metals, and Ag does not oxidize and has high weather resistance because Ag is a noble metal. In addition, this is because the base metal can be made inexpensive while maintaining the above characteristics of Ag.

Further, as the metal included in the conductive resin layer, for example, Cu and Ni which have been subjected to an oxidation prevention treatment can also be used.

As the metal included in the conductive resin layer, for example, a metal powder whose surface is coated with Sn, Ni, and Cu can also be used. In a case of using a metal powder whose surface is coated with Sn, Ni, and Cu, it is preferable to use Ag, Cu, Ni, Sn, Bi, or an alloy powder thereof as the metal powder.

The metal included in the conductive resin layer is mainly responsible for the conductivity of the conductive resin layer. Specifically, the conductive fillers come into contact with each other to form a current path inside the conductive resin layer.

As the metal included in the conductive resin layer, a metal having a spherical shape or a flat shape can be used, and it is preferable to use a mixture of a spherical metal powder and a flat metal powder.

As the resin of the conductive resin layer, for example, various known thermosetting resins such as epoxy resin, phenol resin, urethane resin, silicone resin, and polyimide resin can be used. Among these, an epoxy resin having excellent heat resistance, moisture resistance, close-contact property, and the like is one of the most suitable resins.

In addition, the conductive resin layer preferably includes, for example, a curing agent together with the thermosetting resin. In the curing agent, when the epoxy resin is used as a base resin, various known compounds such as, for example, a phenol-based compound, an amine-based compound, an acid anhydride-based compound, an imidazole-based compound, an active ester-based compound, and an amide-imide-based compound can be used as the curing agent of the epoxy resin.

The conductive resin layer may be a plurality of layers.

A thickness of the conductive resin layer positioned at the central portion in the lamination direction x of the multilayer body 12 positioned on the first end surface 12e and the second end surface 12f is, for example, preferably approximately 10 μm or more and approximately 150 μm or less.

### In Case of Thin Film Layer

In a case where the charging electrode 34 is made of a thin film layer, the thin film layer is formed by a thin film forming method such as a sputtering method or a vapor deposition method, and is, for example, a layer of about 1 μm or less in which metal particles are deposited.

It is preferable that the outer electrode 30 includes the upper plating layer 36.

The upper plating layer 36 preferably includes a first upper plating layer 36a to a fourth upper plating layer 36d.

The first upper plating layer 36a covers the first plating layer 32a and the first charging electrode 34a on the first end surface 12e side.

The second upper plating layer 36b covers the second plating layer 32b and the second charging electrode 34b on the second end surface 12f side.

The third upper plating layer 36c covers the third plating layer 32c and the third charging electrode 34c on the first side surface 12c side.

The fourth upper plating layer 36d covers the fourth plating layer 32d and the fourth charging electrode 34d on the second side surface 12d side.

Each of the upper plating layers 36 includes at least one selected from, for example, Cu, Ni, Sn, Ag, Pd, an Ag—Pd alloy, Au, or the like.

The upper plating layer 36 may include a plurality of layers.

The upper plating layer 36 preferably has a two-layer structure of, for example, a Ni plating layer and a Sn plating layer. The Ni plating layer can prevent the charging electrode 34 from being eroded by solder in a case of mounting the through-type multilayer ceramic capacitor 10, and the Sn plating layer can improve the wettability of solder in a case of mounting the through-type multilayer ceramic capacitor 10, and the through-type multilayer ceramic capacitor 10 can be easily mounted on the mounting substrate. As described above, by forming the upper plating layer 36 with a plurality of layers, the reliability and the mounting property of the through-type multilayer ceramic capacitor 10 can be efficiently improved.

The thickness of each upper plating layer 36 per layer is, for example, preferably about 2 μm or more and about 15 μm or less.

A dimension in the length direction z of the through-type multilayer ceramic capacitor 10 including the multilayer body 12 and the first outer electrode 30a to the fourth outer electrode 30d is defined as an L dimension, a dimension in the lamination direction x of the through-type multilayer ceramic capacitor 10 including the multilayer body 12 and the first outer electrode 30a to the fourth outer electrode 30d is defined as a T dimension, and a dimension in the width direction y of the through-type multilayer ceramic capacitor 10 including the multilayer body 12 and the first outer electrode 30a to the fourth outer electrode 30d is defined as a W dimension.

The dimension of the through-type multilayer ceramic capacitor 10 is not particularly limited, but, for example, the L dimension in the length direction z is about 0.4 mm or more and about 2.0 mm or less, the W dimension in the width direction y is about 0.2 mm or more and about 1.25 mm or less, and the T dimension in the lamination direction x is about 0.1 mm or more and about 2.0 mm or less. The dimensions of the through-type multilayer ceramic capacitor 10 can be measured with a microscope.

The through-type multilayer ceramic capacitor 10 illustrated in FIG. 1 includes the first outer electrode 30a having the first plating layer 32a located on the first end surface 12e and the first charging electrode 34a located on the first end surface 12e and having a length shorter than the length of the first plating layer 32a in the width direction y, the second outer electrode 30b having the second plating layer 32b located on the second end surface 12f and the second charging electrode 34b located on the second end surface 12f and having a length shorter than the length of the second plating layer 32b in the width direction y, the third outer electrode 30c having the third plating layer 32c located on the first side surface 12c and the third charging electrode 34c located on the first side surface 12c and having a length shorter than the length of the third plating layer 32c in the length direction z, and the fourth outer electrode 30d having the fourth plating layer 32d located on the second side surface 12d and the fourth charging electrode 34d located on the second side surface 12d and having a length shorter than the length of the fourth plating layer 32d in the length direction z. Therefore, since the first outer electrode 30a and the second outer electrode 30b do not wrap around the first side surface 12c and the second side surface 12d, the distance between the first outer electrode 30a and the second outer electrode 30b and the third outer electrode 30c can be sufficiently secured, and the distance between the first outer electrode 30a and the second outer electrode 30b and the fourth outer electrode 30d can be sufficiently secured. Therefore, in the through-type multilayer ceramic capacitor 10, an occurrence of short circuit defects or electrochemical migration can be reduced or prevented.

In addition, since the through-type multilayer ceramic capacitor 10 illustrated in FIG. 1 includes the above-described configuration in which the first outer electrode 30a to the fourth outer electrode 30d are provided, it is not necessary to narrow the width of the first inner electrode layer 16a extended to the first end surface 12e and the second end surface 12f and the width of the second inner electrode layer 16b extended to the first side surface 12c and the second side surface 12d. As a result, since the state in which the width of the first extended electrode portion 28a and the width of the second extended electrode portion 28b of the first inner electrode layer 16a are sufficiently secured and the width of the third extended electrode portion 28c and the width of the fourth extended electrode portion 28d of the second inner electrode layer 16b are sufficiently secured can be maintained, the control of the printing on the coating surface of the inner electrode layer 16 is facilitated, and the deterioration of an equivalent series resistance (ESL) and a direct current resistance (Rdc) can be reduced or prevented.

### 2. Manufacturing Method of Through-Type Multilayer Ceramic Capacitor

Next, an example of a manufacturing method of a through-type multilayer ceramic capacitor according to the first example embodiment will be described.

First, a dielectric sheet for a dielectric layer and a conductive paste for an inner electrode layer are prepared. The dielectric sheet and the conductive paste for the inner electrode layer include a binder and a solvent. The binder and the solvent may be known ones.

Then, the conductive paste for the inner electrode layer is printed on the dielectric sheet in a predetermined pattern through, for example, screen printing or gravure printing.

As a result, a dielectric sheet on which a pattern of the first inner electrode layer is formed and a dielectric sheet on which a pattern of the second inner electrode layer is formed are prepared.

More specifically, the inner electrode layer according to the example embodiment of the present invention can be printed by, for example, separately preparing a screen plate for printing the pattern of the first inner electrode layer and a screen plate for printing the pattern of the second inner electrode layer, and using a printer capable of separately printing the two types of screen plates. Here, in order to obtain a desired structure, a sheet on which the pattern of the first inner electrode layer and the pattern of the second inner electrode layer are printed is laminated to manufacture a portion to be an inner layer portion.

Subsequently, by laminating a predetermined number of the dielectric sheets for an outer layer on which the pattern of the inner electrode layer is not printed, a portion that becomes the second main surface-side outer layer portion on the second main surface side is formed. The portion to be the inner layer portion manufactured by the above-described method is laminated on the portion to be the second main surface-side outer layer portion manufactured by the above-described method. Thereafter, by further laminating a predetermined number of dielectric sheets for an outer layer in which the pattern of the inner electrode layer is not printed on the portion that becomes the inner layer portion, the portion to be the first main surface-side outer layer portion on the first main surface side is formed. As a result, the multilayer sheet is produced.

Subsequently, a multilayer block is produced by pressing the multilayer sheet in the lamination direction by means such as isostatic press.

By cutting the multilayer block into a predetermined size, the multilayer chip is cut out. In this case, a corner portion and a ridge portion of the multilayer chip may be rounded through barrel polishing or the like.

Subsequently, the multilayer chip is fired to produce the multilayer body 12.

A firing temperature depends on the materials of the dielectric layer or the inner electrode layer, but is, for example, preferably about 900° C. or more and about 1,400° C. or less.

Subsequently, the plating layer 32 is formed on the multilayer body 12 obtained by the firing.

Specifically, the first plating layer 32a is formed on the first end surface 12e of the multilayer body 12, the second plating layer 32b is formed on the second end surface 12f, the third plating layer 32c is formed on the first side surface 12c, and the fourth plating layer 32d is formed on the second side surface 12d. In the through-type multilayer ceramic capacitor 10 illustrated in FIG. 1, the first plating layer 32a to fourth plating layer 32d are formed of Cu plating.

As a specific method of forming the first plating layer 32a to the fourth plating layer 32d, a method described below can be used.

That is, by performing the plating treatment on the first inner electrode layer 16a exposed on the first end surface 12e and the second end surface 12f of the multilayer body 12, the first plating layer 32a and the second plating layer 32b are formed. Similarly, the third plating layer 32c and the fourth plating layer 32d are formed by performing the plating treatment on the second inner electrode layer 16b exposed on the first side surface 12c and the second side surface 12d of the multilayer body 12. In performing a plating treatment, either electrolytic plating or electroless plating may be adopted, but the electroless plating requires a pretreatment with a catalyst or the like in order to improve a plating deposition rate, which is a disadvantage in that the process becomes complicated. Therefore, it is preferable to adopt the electrolytic plating in general.

Next, the charging electrode 34 is formed on the plating layer 32.

Specifically, the first charging electrode 34a is formed on the first plating layer 32a and the first end surface 12e of the multilayer body 12, the second charging electrode 34b is formed on the second plating layer 32b and the second end surface 12f of the multilayer body 12, the third plating layer 32c is formed on the third plating layer 32c and the first side surface 12c of the multilayer body 12, and the fourth plating layer 32d is formed on the fourth plating layer 32d and the second side surface 12d of the multilayer body 12.

### In Case of Being Formed by Baked Layer

In a case where the first charging electrode 34a to the fourth charging electrode 34d are formed of the baked layer, a conductive paste including a glass component and a metal component is applied to the first end surface 12e, the second end surface 12f, the first side surface 12c, and the second side surface 12d, and then a baking treatment is performed, whereby the baked layer as the charging electrode 34 is formed. A temperature of the baking treatment at this time is, for example, preferably about 700° C. or more and about 900° C. or less. In the through-type multilayer ceramic capacitor 10 illustrated in FIG. 1, the charging electrode 34 is made of the baked layer.

Here, as an example of a method of forming the charging electrode 34 by the baked layer, various methods can be used.

For example, as a method of forming the charging electrode 34 by the baked layer, a method of applying a conductive paste by extruding the conductive paste from a slit can be used. In a case of this method, by increasing the extrusion amount of the conductive paste, the first charging electrode 34a and the second charging electrode 34b can be formed not only on the first end surface 12e and the second end surface 12f but also on a portion of the first main surface 12a and a portion of the second main surface 12b, and the third charging electrode 34c and the fourth charging electrodes 34d can be formed not only on the first side surface 12c and the second side surface 12d but also on a portion of the first main surface 12a and a portion of the second main surface 12b.

In addition, in the method of applying the conductive paste by extruding the conductive paste from the slit, by controlling the width of the slit, the first charging electrode 34a provided with a length shorter than the length of the first plating layer 32a in the width direction y and the second charging electrode 34b provided with a length shorter than the length of the second plating layer 32b in the width direction y can be formed. Similarly, by controlling the width of the slit, the third charging electrode 34c provided with a length shorter than the length of the third plating layer 32c in the length direction z and the fourth charging electrode 34d provided with a length shorter than the length of the fourth plating layer 32d in the length direction z can be formed.

As a method of forming the charging electrode 34 by the baked layer, the charging electrode 34 can also be formed by using a roller transfer method. In a case of the roller transfer method, in a case where the first charging electrode 34a and the second charging electrode 34b are formed not only on the first end surface 12e and the second end surface 12f but also on a portion of the first main surface 12a and a portion of the second main surface 12b, the first charging electrode 34a and the second charging electrode 34b can be formed on the portion of the first main surface 12a and the portion of the second main surface 12b by increasing the pressing pressure during the roller transfer. In addition, in a case of the roller transfer method, in a case where the third charging electrode 34c and the fourth charging electrode 34d are formed not only on the first side surface 12c and the second side surface 12d but also on a portion of the first main surface 12a and a portion of the second main surface 12b, the third charging electrode 34c and the fourth charging electrode 34d can be formed on the portion of the first main surface 12a and the portion of the second main surface 12b by increasing the pressing pressure during the roller transfer.

In addition, in the roller transfer method, by controlling a width of a groove of the roller, the first charging electrode 34a provided with a length shorter than the length of the first plating layer 32a in the width direction y and the second charging electrode 34b provided with a length shorter than the length of the second plating layer 32b in the width direction y can be formed. Similarly, by controlling the width of the groove of the roller, the third charging electrode 34c provided with a length shorter than the length of the third plating layer 32c in the length direction z and the fourth charging electrode 34d provided with a length shorter than the length of the fourth plating layer 32d in the length direction z can be formed.

Thereafter, a baking treatment is performed to form a baked layer as the charging electrode 34. A temperature of the baking treatment at this time is, for example, preferably about 700° C. or more and about 900° C. or less.

### Conductive Resin Layer

In a case where the charging electrode 34 is made of a conductive resin layer, the conductive resin layer can be formed by the following method. The conductive resin layer may be directly formed on the plating layer 32, or may be formed on a surface of the formed baked layer.

In the method for forming the conductive resin layer, for example, a conductive resin paste including a thermosetting resin and a metal component is applied onto the plating layer 32 or the charging electrode 34 located on the first end surface 12e, the second end surface 12f, the first side surface 12c, and the second side surface 12d, and heat-treated at a temperature of about 250° C. or more and about 550° C. or less to thermoset the resin, thereby forming the conductive resin layer. The atmosphere during the heat treatment at this time is, for example, preferably N₂ atmosphere. In addition, in order to prevent scattering of the resin and to prevent oxidation of various metal components, an oxygen concentration is, for example, preferably reduced or prevented to about 100 ppm or less.

As a method of applying the conductive resin paste, for example, a method of extruding the conductive resin paste through a slit and applying the conductive resin paste or a roller transfer method can be used, as with the method of forming the charging electrode 34 with the baked layer.

### Thin Film Layer

In addition, in a case where the charging electrode 34 is made of a thin film layer, the charging electrode can be formed by a thin film forming method such as a sputtering method or a vapor deposition method at a portion where the outer electrode 30 is to be formed, by performing masking or the like. The charging electrode 34 formed of the thin film layer has a layer of, for example, about 1 μm or less in which metal particles are deposited.

Subsequently, as necessary, the upper plating layer 36 is formed on the surface of the plating layer 32 and the surface of the charging electrode 34. The upper plating layer 36 may be located on the surface of the plating layer 32, the surface of the charging electrode 34, and the surface of the multilayer body 12.

In the present example embodiment, the upper plating layer 36 is made of, for example, a Ni plating layer and a Sn plating layer. The Ni plating layer and the Sn plating layer are sequentially formed using, for example, a barrel plating method. In performing the plating treatment, either electrolytic plating or electroless plating may be adopted. Note that, the electroless plating requires a pretreatment with a catalyst or the like in order to improve a plating deposition rate, which is a disadvantage in that the process becomes complicated. Therefore, it is preferable to adopt the electrolytic plating in general.

As described above, the through-type multilayer ceramic capacitor 10 according to the present example embodiment is manufactured.

### B. Second Example Embodiment. Through-Type Multilayer Ceramic Capacitor

A through-type multilayer ceramic capacitor according to a second example embodiment of the present invention will now be described.

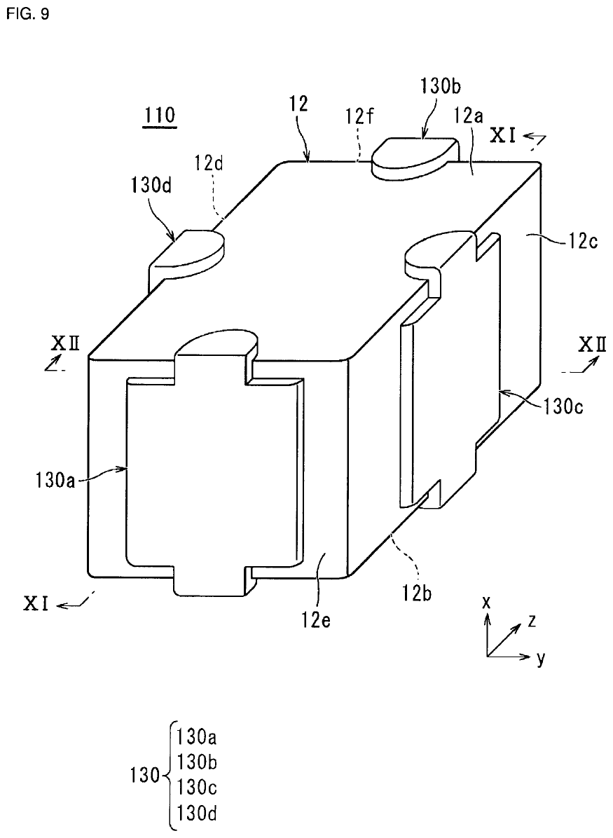

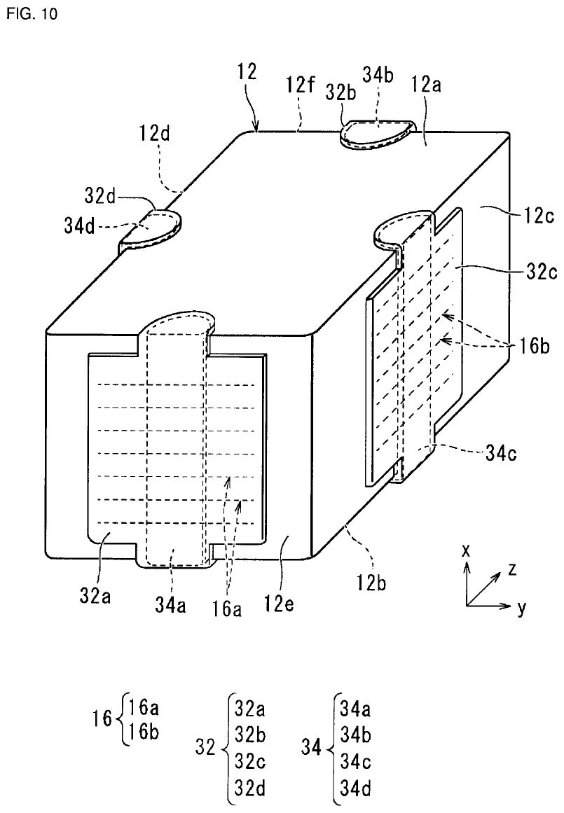

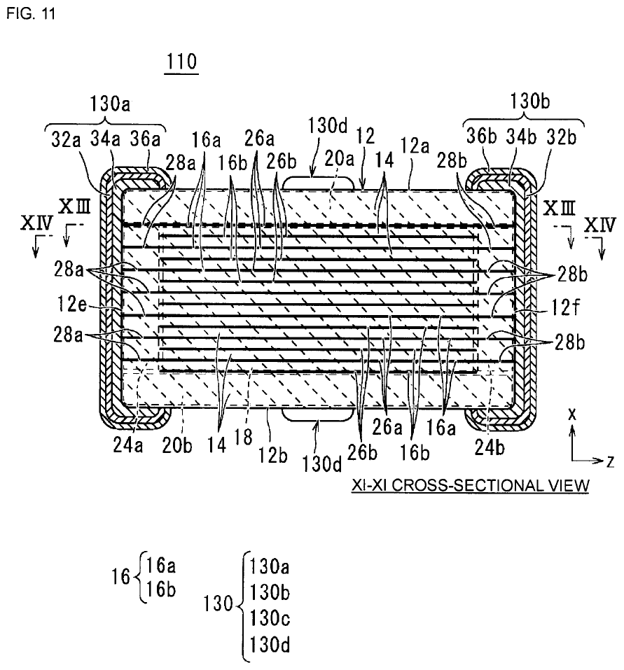

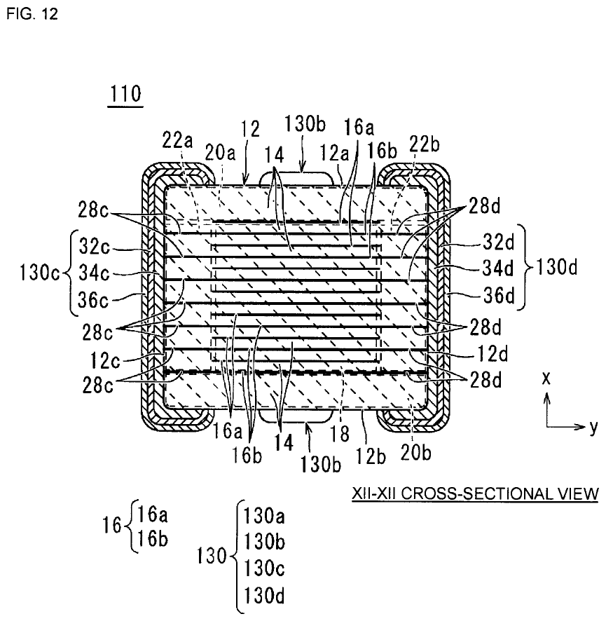

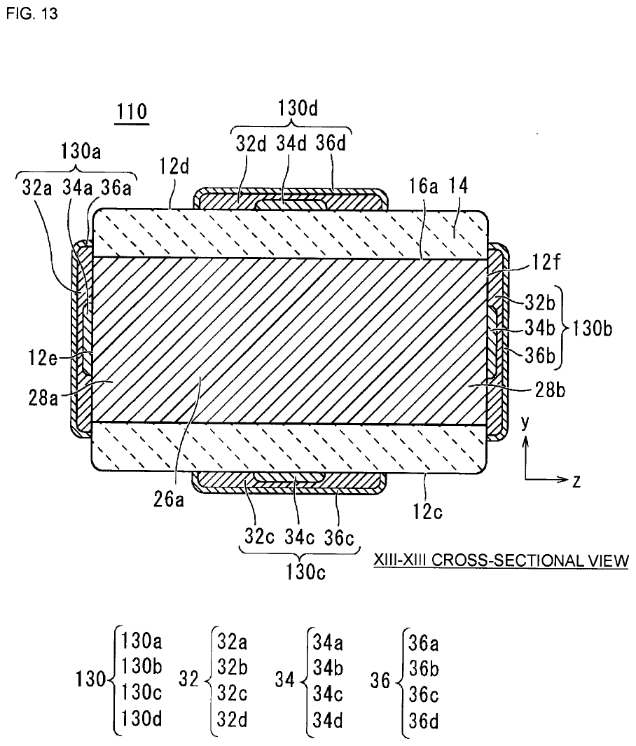

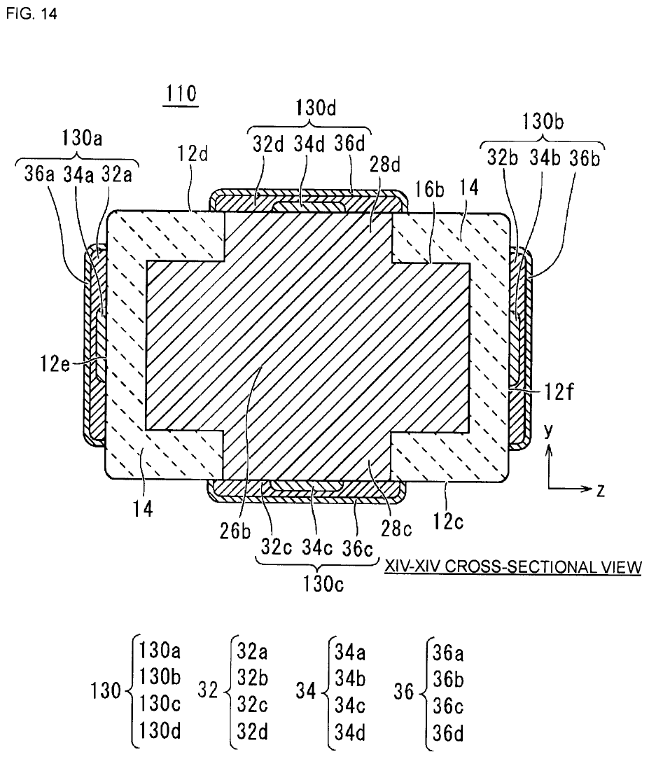

FIG. 9 is an external perspective view illustrating an example of the through-type multilayer ceramic capacitor according to the second example embodiment of the present invention. FIG. 10 is an external perspective view illustrating a state in which a plating layer and a charging electrode are located on a multilayer body of the through-type multilayer ceramic capacitor according to the second example embodiment of the present invention. FIG. 11 is a cross-sectional view taken along line XI-XI in FIG. 9. FIG. 12 is a cross-sectional view taken along line XII-XII in FIG. 9. FIG. 13 is a cross-sectional view taken along line XIII-XIII in FIG. 11. FIG. 14 is a cross-sectional view taken along line XIV-XIV in FIG. 11. In a through-type multilayer ceramic capacitor 110 illustrated in FIGS. 9 to 14, the same parts as those of the through-type multilayer ceramic capacitor 10 illustrated in FIGS. 1 to 8 are designated by the same reference numerals, and the description thereof will be omitted. The through-type multilayer ceramic capacitor 10 according to the second example embodiment has a different configuration of the outer electrode from the through-type multilayer ceramic capacitor 110 according to the first example embodiment.

As illustrated in FIG. 9 to FIG. 14, the through-type multilayer ceramic capacitor 110 includes, for example, a multilayer body 12 and an outer electrode 130.

### (1) Multilayer Body

The multilayer body 12 includes a plurality of laminated dielectric layers 14 and a plurality of inner electrode layers 16.

Since the material of the dielectric layer 14 in the through-type multilayer ceramic capacitor 110 is the same as that of the through-type multilayer ceramic capacitor 10, the description thereof will be omitted.

In addition, since the thickness of the dielectric layer 14 after the firing is also common to the through-type multilayer ceramic capacitor 10, the description thereof will be omitted.

The multilayer body 12 includes a plurality of first inner electrode layers 16a and a plurality of second inner electrode layers 16b as the plurality of inner electrode layers 16. The plurality of first inner electrode layers 16a and the plurality of second inner electrode layers 16b are embedded to be alternately and equally spaced along the lamination direction x of the multilayer body 12 with the dielectric layer 14 interposed therebetween.

As illustrated in FIG. 13, the first inner electrode layer 16a includes the first opposing electrode portion 26a opposing the second inner electrode layer 16b with the dielectric layer 14 interposed therebetween, and a first extended electrode portion 28a extended from the first opposing electrode portion 26a to the surface of the first end surface 12e of the multilayer body 12 and a second extended electrode portion 28b extended from the first opposing electrode portion 26a to the surface of the second end surface 12f of the multilayer body 12.

As illustrated in FIG. 14, the second inner electrode layer 16b has a substantially cross shape, and includes a second opposing electrode portion 26b opposing the first inner electrode layer 16a with the dielectric layer 14 interposed therebetween, a third extended electrode portion 28c extended from the second opposing electrode portion 26b to the surface of the first side surface 12c of the multilayer body 12, and a fourth extended electrode portion 28d extended from the second opposing electrode portion 26b to the surface of the second side surface 12d of the multilayer body 12.

### (2) Outer Electrode

The outer electrodes 130 are located on the first end surface 12e side and the second end surface 12f side of the multilayer body 12, and on the first side surface 12c side and the second side surface 12d side.

The outer electrode 130 includes a plating layer 32 and a charging electrode 34. The plating layer 32 covers the charging electrode 34. In addition, the outer electrode 130 includes an upper plating layer 36 so as to cover the plating layer 32. The upper plating layer 36 is not necessarily included in the outer electrode 130.

The outer electrode 130 includes a first outer electrode 130a, a second outer electrode 130b, a third outer electrode 130c, and a fourth outer electrode 130d.

The first outer electrode 130a is located on the first end surface 12e and is connected to the first inner electrode layer 16a. The first outer electrode 130a covers the first inner electrode layer 16a, and includes the first charging electrode 34a located on the first end surface 12e, and the first plating layer 32a located on the first end surface 12e and located on the first charging electrode 34a and the first inner electrode layer 16a. In this case, the first outer electrode 130a is electrically connected to the first extended electrode portion 28a of the first inner electrode layer 16a. The length of the first charging electrode 34a in the width direction y is smaller than the length of the first plating layer 32a in the width direction y.

The second outer electrode 130b is located on the second end surface 12f and is connected to the first inner electrode layer 16a. The second outer electrode 130b covers the first inner electrode layer 16a, and includes the second charging electrode 34b located on the second end surface 12f, and the second plating layer 32b located on the second end surface 12f and located on the second charging electrode 34b and the first inner electrode layer 16a. In this case, the second outer electrode 130b is electrically connected to the second extended electrode portion 28b of the first inner electrode layer 16a. The length of the second charging electrode 34b in the width direction y is smaller than the length of the second plating layer 32b in the width direction y.

The third outer electrode 130c is located on the first side surface 12c and is connected to the second inner electrode layer 16b. The third outer electrode 130c covers the second inner electrode layer 16b, and includes the third charging electrode 34c located on the first side surface 12c, and the third plating layer 32c located on the first side surface 12c and located on the third charging electrode 34c and the second inner electrode layer 16b. In this case, the third outer electrode 130c is electrically connected to the third extended electrode portion 28c of the second inner electrode layer 16b. A length of the third charging electrode 34c in the length direction z is smaller than a length of the third plating layer 32c in the length direction z.

The fourth outer electrode 130d is located on the second side surface 12d and is connected to the second inner electrode layer 16b. The fourth outer electrode 130d covers the second inner electrode layer 16b, and includes the fourth charging electrode 34d located on the second side surface 12d, and the fourth plating layer 32d located on the second side surface 12d and located on the fourth charging electrode 34d and the second inner electrode layer 16b. In this case, the fourth outer electrode 130d is electrically connected to the fourth extended electrode portion 28d of the second inner electrode layer 16b. A length of the fourth charging electrode 34d in the length direction z is smaller than a length of the fourth plating layer 32d in the length direction z.

In the multilayer body 12, the first opposing electrode portion 26a of the first inner electrode layer 16a and the second opposing electrode portion 26b of the second inner electrode layer 16b oppose each other with the dielectric layer 14 interposed therebetween to form electrostatic capacity. Therefore, electrostatic capacity can be obtained between the first outer electrode 130a and the second outer electrode 130b to which the first inner electrode layer 16a is connected and the third outer electrode 130c and the fourth outer electrode 130d to which the second inner electrode layer 16b is connected, and characteristics of the capacitor are expressed.

As illustrated in FIG. 10, the charging electrode 34 covers the inner electrode layer 16 exposed on the surface of the multilayer body 12.

The first charging electrode 34a covers the first inner electrode layer 16a, which is extended to and exposed on the first end surface 12e.

The second charging electrode 34b covers the first inner electrode layer 16a, which is extended to and exposed on the second end surface 12f.

The third charging electrode 34c covers the second inner electrode layer 16b, which is extended to and exposed on the first side surface 12c.

The fourth charging electrode 34d covers the second inner electrode layer 16b, which is extended to and exposed on the second side surface 12d.

As illustrated in FIG. 10, the plating layer 32 covers the inner electrode layer 16 and the charging electrode 34 exposed on the surface of the multilayer body 12.

The first plating layer 32a covers the first inner electrode layer 16a, which is extended to the first charging electrode 34a and the first end surface 12e and is exposed, on the first end surface 12e side.

The second plating layer 32b covers the first inner electrode layer 16a, which is extended to the second charging electrode 34b and the second end surface 12f and is exposed, on the second end surface 12f side.

The third plating layer 32c covers the second inner electrode layer 16b, which is extended to the third charging electrode 34c and the first side surface 12c and is exposed, on the first side surface 12c side.

The fourth plating layer 32d covers the second inner electrode layer 16b, which is extended to the fourth charging electrode 34d and the second side surface 12d and is exposed, on the second side surface 12d side.

As a result, since the first charging electrode 34a, the second charging electrode 34b, the third charging electrode 34c, and the fourth charging electrode 34d are located on the surface of the multilayer body 12 first, a portion which is a starting point for the growth of plating in a case of forming the first plating layer 32a to the fourth plating layer 32d can be secured first, and thus, the first plating layer 32a to the fourth plating layer 32d can be formed in a short time.

The lengths of the first plating layer 32a and the second plating layer 32b in the width direction y are smaller than the length of the multilayer body 12 in the width direction y.

The lengths of the first plating layer 32a and the second plating layer 32b in the lamination direction x are smaller than the length of the multilayer body 12 in the lamination direction x.

The lengths of the third plating layer 32c and the fourth plating layer 32d in the length direction z are smaller than the length of the multilayer body 12 in the length direction z.

The lengths of the third plating layer 32c and the fourth plating layer 32d in the lamination direction x are smaller than the length of the multilayer body 12 in the lamination direction X.

It is preferable that the outer electrode 130 includes the upper plating layer 36.

The upper plating layer 36 has a first upper plating layer 36a to a fourth upper plating layer 36d.

The first upper plating layer 36a covers the first plating layer 32a on the first end surface 12e side.

The second upper plating layer 36b covers the second plating layer 32b on the second end surface 12f side, and the third upper plating layer 36c covers the third plating layer 32c on the first side surface 12c side.

The fourth upper plating layer 36d covers the fourth plating layer 32d on the second side surface 12d side.

The materials of the plating layer 32, the charging electrode 34, and the upper plating layer 36, and the like in the through-type multilayer ceramic capacitor 110 are common to those of the through-type multilayer ceramic capacitor 10, and thus the description thereof will be omitted.

In the through-type multilayer ceramic capacitor 110 illustrated in FIG. 9, the same effects as those of the through-type multilayer ceramic capacitor 10 described above are exhibited.

### 2. Manufacturing Method of Through-Type Multilayer Ceramic Capacitor

Next, an example of a manufacturing method of a through-type multilayer ceramic capacitor according to the second example embodiment will be described.

First, a dielectric sheet for a dielectric layer and a conductive paste for an inner electrode layer are prepared. The dielectric sheet and the conductive paste for the inner electrode layer include a binder and a solvent. The binder and the solvent may be known ones.

Then, the conductive paste for the inner electrode layer is printed on the dielectric sheet in a predetermined pattern through, for example, screen printing or gravure printing.

As a result, a dielectric sheet on which a pattern of the first inner electrode layer is formed and a dielectric sheet on which a pattern of the second inner electrode layer is formed are prepared.

More specifically, the inner electrode layer according to the example embodiment of the present invention can be printed by separately preparing a screen plate for printing the pattern of the first inner electrode layer and a screen plate for printing the pattern of the second inner electrode layer, and using a printer capable of separately printing the two types of screen plates. Here, in order to obtain a desired structure, a sheet on which the pattern of the first inner electrode layer and the pattern of the second inner electrode layer are printed is laminated to manufacture a portion to be an inner layer portion.

Subsequently, by laminating a predetermined number of the dielectric sheets for an outer layer on which the pattern of the inner electrode layer is not printed, a portion that becomes the second main surface-side outer layer portion on the second main surface side is formed. The portion to be the inner layer portion manufactured by the above-described method is laminated on the portion to be the second main surface-side outer layer portion manufactured by the above-described method. Thereafter, by further laminating a predetermined number of dielectric sheets for an outer layer in which the pattern of the inner electrode layer is not printed on the portion that becomes the inner layer portion, the portion to be the first main surface-side outer layer portion on the first main surface side is formed. As a result, the multilayer sheet is produced.

Subsequently, a multilayer block is produced by pressing the multilayer sheet in the lamination direction by means such as isostatic press.

By cutting the multilayer block into a predetermined size, the multilayer chip is cut out. In this case, a corner portion and a ridge portion of the multilayer chip may be rounded through barrel polishing or the like.

Subsequently, the multilayer chip is fired to produce the multilayer body 12.

A firing temperature depends on the materials of the dielectric layer or the inner electrode layer, but is preferably 900° C. or more and 1,400° C. or less.

Subsequently, the charging electrode 34 constituting the outer electrode 130 is formed on the multilayer body 12 obtained by the firing.

Specifically, the first charging electrode 34a is formed on the first end surface 12e of the multilayer body 12, the second charging electrode 34b is formed on the second end surface 12f of the multilayer body 12, the third plating layer 32c is formed on the first side surface 12c of the multilayer body 12, and the fourth plating layer 32d is formed on the second side surface 12d of the multilayer body 12.

### In Case of Being Formed by Baked Layer

In a case where the first charging electrode 34a to the fourth charging electrode 34d are formed of the baked layer, a conductive paste including a glass component and a metal component is applied to the first end surface 12e, the second end surface 12f, the first side surface 12c, and the second side surface 12d, and then a baking treatment is performed, whereby the baked layer as the charging electrode 34 is formed. A temperature of the baking treatment at this time is, for example, preferably about 700° C. or more and about 900° C. or less. In the through-type multilayer ceramic capacitor 110 illustrated in FIG. 9, the charging electrode 34 is made of a baked layer.

Here, as an example of a method of forming the charging electrode 34 by the baked layer, various methods can be used.

For example, as a method of forming the charging electrode 34 by the baked layer, a method of applying a conductive paste by extruding the conductive paste from a slit can be used. In a case of this method, by increasing the extrusion amount of the conductive paste, the first charging electrode 34a and the second charging electrode 34b can be formed not only on the first end surface 12e and the second end surface 12f but also on a portion of the first main surface 12a and a portion of the second main surface 12b, and the third charging electrode 34c and the fourth charging electrodes 34d can be formed not only on the first side surface 12c and the second side surface 12d but also on a portion of the first main surface 12a and a portion of the second main surface 12b.

In addition, in the method of applying the conductive paste by extruding the conductive paste from the slit, by controlling the width of the slit, the first charging electrode 34a provided with a length shorter than the length of the first plating layer 32a in the width direction y and the second charging electrode 34b provided with a length shorter than the length of the second plating layer 32b in the width direction y can be formed. Similarly, by controlling the width of the slit, the third charging electrode 34c provided with a length shorter than the length of the third plating layer 32c in the length direction z and the fourth charging electrode 34d provided with a length shorter than the length of the fourth plating layer 32d in the length direction z can be formed.

As an example of a method of forming the charging electrode 34 by the baked layer, the charging electrode 34 can also be formed by using a roller transfer method. In a case of the roller transfer method, in a case where the first charging electrode 34a and the second charging electrode 34b are formed not only on the first end surface 12e and the second end surface 12f but also on a portion of the first main surface 12a and a portion of the second main surface 12b, the first charging electrode 34a and the second charging electrode 34b can be formed on the portion of the first main surface 12a and the portion of the second main surface 12b by increasing the pressing pressure during the roller transfer. In addition, in a case of the roller transfer method, in a case where the third charging electrode 34c and the fourth charging electrode 34d are formed not only on the first side surface 12c and the second side surface 12d but also on a portion of the first main surface 12a and a portion of the second main surface 12b, the third charging electrode 34c and the fourth charging electrode 34d can be formed on the portion of the first main surface 12a and the portion of the second main surface 12b by increasing the pressing pressure during the roller transfer.

In addition, in the roller transfer method, by controlling a width of a groove of the roller, the first charging electrode 34a provided with a length shorter than the length of the first plating layer 32a in the width direction y and the second charging electrode 34b provided with a length shorter than the length of the second plating layer 32b in the width direction y can be formed. Similarly, by controlling the width of the groove of the roller, the third charging electrode 34c provided with a length shorter than the length of the third plating layer 32c in the length direction z and the fourth charging electrode 34d provided with a length shorter than the length of the fourth plating layer 32d in the length direction z can be formed.

Thereafter, a baking treatment is performed to form a baked layer as the charging electrode 34. A temperature of the baking treatment at this time is, for example, preferably about 700° C. or more and about 900°° C. or less.

### Conductive Resin Layer

In a case where the charging electrode 34 is made of a conductive resin layer, the conductive resin layer can be formed by the following method. The conductive resin layer may be formed directly on the multilayer body 12, or may be formed on the surface of the formed baked layer.

As an example of a method for forming the conductive resin layer, a conductive resin paste including a thermosetting resin and a metal component is applied onto the first end surface 12e, the second end surface 12f, the first side surface 12c, and the second side surface 12d or the charging electrode 34, and heat-treated at a temperature of, for example, about 250° C. or more and about 550° C. or less to thermoset the resin, thereby forming the conductive resin layer. The atmosphere during the heat treatment at this time is preferably N₂ atmosphere. In addition, in order to prevent scattering of the resin and to prevent oxidation of various metal components, an oxygen concentration is, for example, preferably reduced or prevented to about 100 ppm or less.

As an example of a method of applying the conductive resin paste, for example, a method of extruding the conductive resin paste through a slit and applying the conductive resin paste or a roller transfer method can be used, as with the method of forming the charging electrode 34 with the baked layer.

### Thin Film Layer

In addition, in a case where the charging electrode 34 is made of a thin film layer, the charging electrode can be formed by a thin film forming method such as a sputtering method or a vapor deposition method at a portion where the outer electrode 130 is to be formed, by performing masking or the like. The charging electrode 34 formed of the thin film layer has a layer of, for example, about 1 μm or less in which metal particles are deposited.

Next, the plating layer 32 is formed on the charging electrode 34 and the inner electrode layer 16 exposed from the multilayer body 12.

Specifically, the first plating layer 32a is formed on the first inner electrode layer 16a exposed by being extended to the first charging electrode 34a and the first end surface 12e of the multilayer body 12, the second plating layer 32b is formed on the first inner electrode layer 16a exposed by being extended to the second charging electrode 34b and the second end surface 12f, the third plating layer 32c is formed on the second inner electrode layer 16b exposed by being extended to the third charging electrode 34c and the first side surface 12c, and the fourth plating layer 32d is formed on the second inner electrode layer 16b exposed by being extended to the fourth charging electrode 34d and the second side surface 12d. In the through-type multilayer ceramic capacitor 110 illustrated in FIG. 9, the first plating layer 32a to the fourth plating layer 32d are formed of Cu plating.

As a specific method of forming the first plating layer 32a to the fourth plating layer 32d, a method described below can be used.

That is, the first and second charging electrodes 34a and 34b, and the first inner electrode layer 16a exposed on the first end surface 12e and the second end surface 12f of the multilayer body 12 is subjected to a plating treatment, whereby the first plating layer 32a and the second plating layer 32b are formed. Similarly, the third charging electrode 34c and the fourth charging electrode 34d, and the second inner electrode layer 16b exposed on the first side surface 12c and the second side surface 12d of the multilayer body 12 are subjected to a plating treatment, whereby the third plating layer 32c and the fourth plating layer 32d are formed. In performing a plating treatment, either electrolytic plating or electroless plating may be adopted, but the electroless plating requires a pretreatment with a catalyst or the like in order to improve a plating deposition rate, which is a disadvantage in that the process becomes complicated. Therefore, it is preferable to adopt the electrolytic plating in general.

Subsequently, as necessary, the upper plating layer 36 is formed on the surface of the plating layer 32. The upper plating layer 36 may be disposed not only on the surface of the plating layer 32 but also on the surface of the multilayer body 12.

In the present example embodiment, the upper plating layer 36 is made of a Ni plating layer and a Sn plating layer. The Ni plating layer and the Sn plating layer are sequentially formed using, for example, a barrel plating method. In performing the plating treatment, either electrolytic plating or electroless plating may be adopted. Note that, the electroless plating requires a pretreatment with a catalyst or the like in order to improve a plating deposition rate, which is a disadvantage in that the process becomes complicated. Therefore, it is preferable to adopt the electrolytic plating in general.

As described above, the example embodiments of the present invention are disclosed in the above description, but the present invention is not limited thereto.

That is, without departing from the scope of the technical idea and the object of the present invention, various changes can be made to the above-described example embodiments in terms of mechanisms, shapes, materials, quantities, positions, arrangements, and the like, and these are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A through-type multilayer ceramic capacitor comprising:
a multilayer body including a plurality of dielectric layers which are laminated, and a plurality of inner electrode layers laminated on the dielectric layers, the multilayer body including a first main surface and a second main surface which oppose each other in a lamination direction, a first side surface and a second side surface which oppose each other in a width direction orthogonal or substantially orthogonal to the lamination direction, a first end surface and a second end surface which oppose each other in a length direction orthogonal or substantially orthogonal to the lamination direction and the width direction;
a first inner electrode layer among the plurality of inner electrode layers extends to the first end surface and the second end surface;
a second inner electrode layer among the plurality of inner electrode layers extends to the first side surface and the second side surface;
a first outer electrode located on the first end surface and connected to the first inner electrode layer;
a second outer electrode located on the second end surface and connected to the first inner electrode layer;
a third outer electrode located on the first side surface and connected to the second inner electrode layer; and
a fourth outer electrode located on the second side surface and connected to the second inner electrode layer; wherein
the first outer electrode includes a first plating layer located on the first end surface, and a first charging electrode located on the first end surface and including a length shorter than a length of the first plating layer in the width direction;
the second outer electrode includes a second plating layer located on the second end surface, and a second charging electrode located on the second end surface and including a length shorter than a length of the second plating layer in the width direction;
the third outer electrode includes a third plating layer located on the first side surface, and a third charging electrode located on the first side surface and including a length shorter than a length of the third plating layer in the length direction; and
the fourth outer electrode includes a fourth plating layer located on the second side surface, and a fourth charging electrode located on the second side surface and including a length shorter than a length of the fourth plating layer in the length direction.

2. The through-type multilayer ceramic capacitor according to claim 1, wherein
the lengths of the first plating layer and the second plating layer in the width direction are smaller than a length of the multilayer body in the width direction;
the lengths of the first plating layer and the second plating layer in the lamination direction are smaller than a length of the multilayer body in the lamination direction;
the lengths of the third plating layer and the fourth plating layer in the length direction are smaller than the length of the multilayer body in the length direction; and
lengths of the third plating layer and the fourth plating layer in the lamination direction are smaller than the length of the multilayer body in the lamination direction.

3. The through-type multilayer ceramic capacitor according to claim 1, wherein
the first plating layer and the second plating layer cover the first inner electrode layer;
the third plating layer and the fourth plating layer cover the second inner electrode layer;
the first charging electrode is located on the first plating layer and a surface of the first end surface;
the second charging electrode is located on the second plating layer and a surface of the second end surface;
the third charging electrode is located on the third plating layer and a surface of the first side surface; and
the fourth charging electrode is located on the fourth plating layer and a surface of the second side surface.

4. The through-type multilayer ceramic capacitor according to claim 1, wherein
the first charging electrode and the second charging electrode cover the first inner electrode layer;
the third charging electrode and the fourth charging electrode cover the second inner electrode layer;
the first plating layer is located on the first charging electrode and the first inner electrode layer;
the second plating layer is located on the second charging electrode and the first inner electrode layer;
the third plating layer is located on the third charging electrode and the second inner electrode layer; and
the fourth plating layer is located on the fourth charging electrode and the second inner electrode layer.

5. The through-type multilayer ceramic capacitor according to claim 1, wherein the first charging electrode and the second charging electrode and the third charging electrode and the fourth charging electrode each extend to a portion of the first main surface and a portion of the second main surface.

6. The through-type multilayer ceramic capacitor according to claim 1, wherein the first plating layer to the fourth plating layer are Cu plating layers.

7. The through-type multilayer ceramic capacitor according to claim 1, wherein an upper plating layer is located on the first plating layer through the fourth plating layer, and on the first charging electrode through the fourth charging electrode.

8. The through-type multilayer ceramic capacitor according to claim 1, wherein
the first inner electrode layer includes a first opposing electrode portion opposing the second inner electrode layer, a first extended electrode portion extending from the first opposing electrode portion to the first end surface and a second extended electrode portion extending from the first opposing electrode portion the second end surface; and
the second inner electrode includes a second opposing electrode portion opposing the first inner electrode layer, a third extended electrode portion extending from the second opposing electrode portion to the first side surface, and a fourth extended electrode portion extending to the second side surface.

9. The through-type multilayer ceramic capacitor according to claim 8, wherein
the first plating layer directly covers the first extended electrode portion which is exposed on the first end surface; and
the second plating layer directly covers the second extended electrode portion which is exposed on the second end surface.

10. The through-type multilayer ceramic capacitor according to claim 4, wherein metal of the first inner electrode layer and the second inner electrode layer is diffused into the first plating layer through the fourth plating layer.

11. The through-type multilayer ceramic capacitor according to claim 4, wherein a thickness of each layer of the first plating layer through the fourth plating layer is about 2 μm or more and about 30 μm or less.

12. The through-type multilayer ceramic capacitor according to claim 1, wherein the first charging electrode, the second charging electrode, the third charging electrode, and the fourth charging electrode are defined by a baked layer including a glass component and a metal component.
